(19) United States
(12) Patent Application Publication
(10) Pub. No.: US 2025/0284343 A1
(43) Pub. Date: Sep. 11, 2025

(54) FINGER GESTURE RECOGNITION USING ANTENNA IN RING

(71) Applicant: PLUME DESIGN, INC., Palo Alto, CA (US)

(72) Inventors: Miroslav SAMARDZIJA, Mountain View, CA (US); ShuChun SHEN, New Taipei City (TW); Liem Hieu Dinh VO, San Jose, CA (US)

(21) Appl. No.: 18/415,973

(22) Filed: Jan. 18, 2024

(51) Int. Cl. G06F 3/01; G06F 1/16; G06F 21/31; G06F 21/44; H01Q 1/27

(52) U.S. Cl. CPC G06F 3/017; G06F 1/163; G06F 3/014; G06F 21/31; G06F 21/44; H01Q 1/273

(57) ABSTRACT

Rings and systems for finger gesture recognition include at least one antenna, a vector network analyzer (VNA), and a processor. The VNA may be configured to drive a test signal into the antenna(s) and measure a reflected frequency response. The processor may be configured to map the reflected frequency response to finger gestures performed by a user wearing the ring. Various other related systems and methods are also disclosed.

### BRIEF DESCRIPTION OF THE DRAWINGS

FIG. 1 is a cross-sectional view of a ring with finger gesture recognition capabilities, according to at least one embodiment of the present disclosure.

FIG. 2 is a schematic diagram of a system for finger gesture recognition, according to at least one embodiment of the present disclosure.

FIG. 3 is an illustration of a frequency response map based on measuring various signal attributes during a finger gesture recognition operation, according to at least one embodiment of the present disclosure.

FIG. 4 is a flow diagram illustrating a method of forming a ring with finger gesture recognition capabilities, according to at least one embodiment of the present disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

Smart rings are wearable electronic devices that fit on a finger of a user like a typical ring. Smart rings are often configured to measure user data, such as heart rate, blood oxygen level, physical activity, body temperature, sleep cycles, etc. Smart rings can include one or more onboard batteries, one or more antennas, one or more sensors, and electronic circuitry for operating the sensors, storing information, and communicating information with another device (e.g., a mobile phone, a personal computer, etc.). For example, a short-range communication (e.g., BLUETOOTH®) or WiFi antenna may be used for wireless communication with the other device. A near-field communication (NFC) antenna may be used for wireless payments and/or user authentication, as well as for wireless charging of the smart ring.

User authentication for a smart ring is often performed by pairing the ring to a smart phone and associating the ring to the user so that others cannot use the ring in case it becomes lost or stolen.

Sign language is widely used by those who are deaf or hard of hearing. Those who do not understand sign language (e.g., those who are not hard of hearing) often have difficulty communicating with those who do speak using sign language. There are some technological solutions that use a camera to capture hand and finger gestures performed by one using sign language and interpret those gestures into a language (verbal or written) that someone else can understand.

The present disclosure provides detailed descriptions of smart rings and related systems and methods. As will be explained in greater detail below, embodiments of the present disclosure may include rings and systems that can correlate finger gestures with signals from one or more antennas, such as for user authentication and/or for sign language interpretation. In some embodiments, the rings may include at least one antenna for transmitting a wireless signal. A vector network analyzer may be operably coupled to the antenna(s) and may be configured to drive a test signal into the at least one antenna and measure a reflected frequency response of a reflected signal returning to the vector network analyzer from the antenna(s). A processor may be configured to map the reflected frequency response to finger gestures performed by a user wearing the ring, such as for sign language interpretation and/or user authentication.

Features from any of the embodiments described herein may be used in combination with one another in accordance with the general principles described herein. These and other embodiments, features, and advantages will be more fully understood upon reading the following detailed description in conjunction with the accompanying drawings and claims.

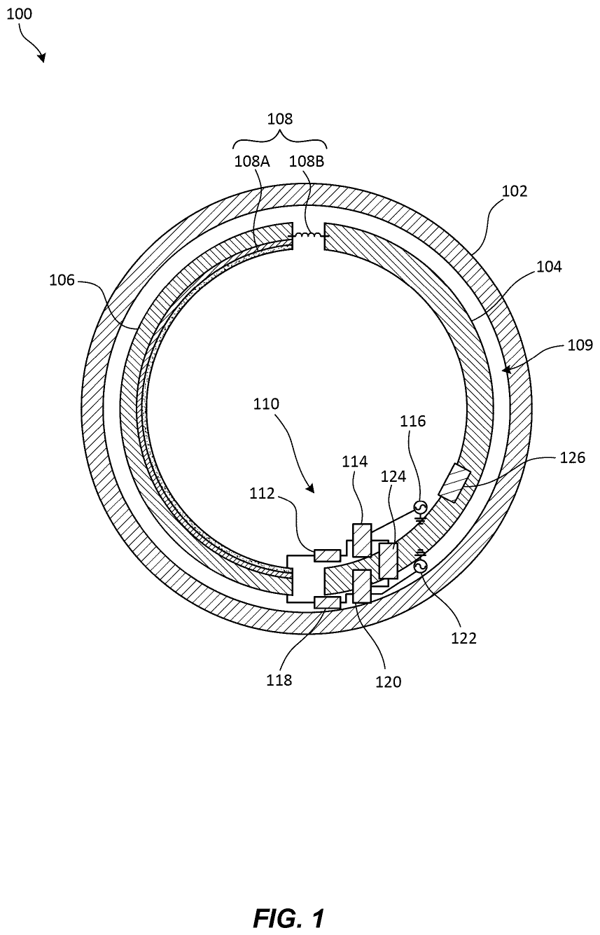

FIG. 1 is a cross-sectional view of a ring 100 with finger gesture recognition capabilities, according to at least one embodiment of the present disclosure. The ring 100 may include an outer bezel 102 of metal, wood, polymer, ceramic, or a combination thereof. A curved printed circuit board (PCB) 104, a battery 106, and at least one antenna 108 may be positioned on an inner side of the outer bezel 102. In some examples, these components may be separated from the outer bezel 102 by a separation gap 109, which may be filled with an adhesive, a polymer, and/or a standoff.

The curved PCB 104 may be a so-called “flexible PCB” that is bent to fit along and within the outer bezel 102, such as at least partially within an inner groove formed on an inner side of the outer bezel 102. The curved PCB 104 may support at least some electronic circuitry 110 for operating the ring 100. For example, the electronic circuitry 110 may include an NFC matching element 112, a first switch 114, and an NFC feed element 116 for interfacing with and operating an NFC antenna 108A. The electronic circuitry 110 may also include a short-range communication (e.g., BLUETOOTH®) matching element 118, a second switch 120, and a short-range communication feed element 122 for interfacing with and operating a short-range communication antenna 108B.

The electronic circuitry 110 may also include a vector network analyzer (VNA) 124. The VNA 124 may be a two-port VNA, with one port operably coupled to the NFC antenna 108A (e.g., through the first switch 114 and the NFC matching element 112) and another port operably coupled to the short-range communication antenna 108B (e.g., through the second switch 120 and the short-range communication matching element 118).

The VNA 124 may be configured to drive a test signal into one or both of the antennas 108 and to measure a reflected frequency response of a reflected signal returning to the VNA 124 from the antenna(s) 108. For example, the VNA 124 may be configured to measure an amplitude of the reflected frequency response and/or a phase of the reflected frequency response. The VNA 124 may also be configured to measure a transmitted frequency response (e.g., amplitude and/or phase) of the test signal driven by the VNA 124 into the antenna(s) 108. The test signal driven to the antenna(s) 108 may be a continuous test signal, such as continuous over a sampling time period.

In some embodiments, the electronic circuitry 110 may also include a processor 126, such as in a microcontroller unit. The processor 126 may be operably coupled to the VNA 124 and may be configured to receive data indicative of the frequency response(s) measured by the VNA 124. The processor 126 may be configured to map the reflected frequency response and/or transmitted frequency response to finger gestures performed by a user wearing the ring. For example, wireless signals from the antenna(s) 108 may be affected by the presence, location, shape, and material properties of physical objects near the ring 100. Accordingly, finger and hand position may alter the reflected frequency response and/or transmitted frequency response as measured by the VNA 124. For example, the user's hand and fingers in a first position, such as holding up an index finger while the other fingers are clenched in a fist, may result in a first frequency response. The user's hand and fingers in a second, different position, such as holding up an index finger and a middle finger while the other fingers are clenched in a fist, may result in a second frequency response different from the first frequency response. By mapping the frequency responses to various hand and finger positions (e.g., in response to instructions provided to the user to hold the hand and fingers in different positions), the processor 126 may facilitate identifying the hand and finger positions, such as for user authentication and/or sign language interpretation.

The processor 126 may also be configured for controlling other operations of the ring 100, such as sensing operations, data storage operations, communication operations (e.g., using the antenna(s) 108 and/or a direct contact communication subsystem), battery charging operations, etc.

The battery 106 may be a curved battery shaped and sized to fit along an inner surface of the outer bezel 102, such as at least partially within an inner groove formed in the outer bezel 102. The battery 106 may be operably coupled to the electronic circuitry 110 to provide electrical power to components of the electronic circuitry 110. In some examples, as illustrated in FIG. 1, at least a portion of the antenna(s) 108 may be positioned along the battery 106. In additional examples, at least a portion of the antenna(s) 108 may be positioned along the curved PCB 104 or along both the battery 106 and the curved PCB 104.

In some embodiments, the NFC antenna 108A may be configured to wirelessly charge the ring. Alternatively or additionally, the NFC antenna 108A may be used to complete an NFC payment transaction, such as by authenticating the user at a payment kiosk with NFC payment capabilities. By way of example, the user may position the ring 100 close to a payment kiosk such that a wireless signal may be transmitted between the NFC antenna 108A and the payment kiosk. If the ring 100 was previously authenticated to the user (e.g., by pairing the ring 100 to a mobile device of the user), the NFC payment may be authenticated. In another example, the user may perform one or more predetermined finger movements (e.g., a sequence of sign language numbers and/or letters, a sequence of hand positions, etc.) that are sensed by the VNA 124 and/or processor 126 as explained above. These finger movement(s) may act as an authentication passcode and, in some embodiments, may be used to authenticate the user on the ring 100 itself without communication with a mobile or other external device. Even during normal use when a payment transaction is not being completed, similar user authentication may be performed for verifying that the person wearing the ring 100 is an authorized user.

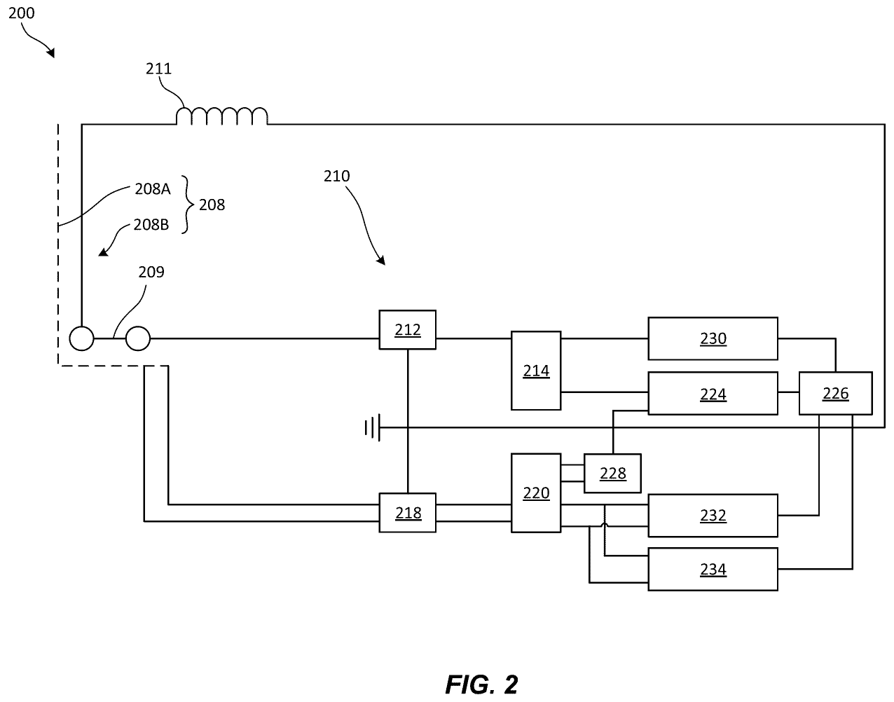

FIG. 2 is a schematic diagram of a system 200 for finger gesture recognition, according to at least one embodiment of the present disclosure. The system 200 may be employed on a ring, such as on the ring 100 described above with reference to FIG. 1.

The system 200 may include at least one antenna 208, such as an NFC antenna 208A and a short-range communication (e.g., BLUETOOTH®) antenna 208B. By way of example and not limitation, the short-range communication antenna 208B may be bounded by a feed bridge 209 and a choke 211. Electronic circuitry 210 may be operably connected to the antenna(s) 208 and may be configured to operate the antenna(s) 208.

For example, the electronic circuitry 210 may include an NFC matching element 212 and a first switch 214 associated with the NFC antenna 208A. The electronic circuitry 210 may also include a short-range communication matching element 218 and a second switch 220 associated with the short-range communication antenna 208B. In addition, a VNA 224 may be operably coupled to the NFC antenna 208A (e.g., through the NFC matching element 212 and the first switch 214) and to the short-range communication antenna 208B (e.g., through the short-range communication matching element 218 and the second switch 220). In some examples, a balun 228 may be positioned between the VNA 224 and the second switch 220, as illustrated in FIG. 2. The VNA 224 may be configured to drive a test signal into one or both of the antennas 208 and to measure a reflected frequency response (e.g., amplitude and/or phase) of a reflected signal returning to the VNA 224 from the antenna(s) 208. The VNA 224 may also be configured to measure a transmitted frequency response (e.g., amplitude and/or phase) of the test signal driven by the VNA 224 into the antenna(s) 208.

A processor 226 (e.g., of a microcontroller unit) may be operably coupled to the VNA 224 and may be configured to receive data indicative of the frequency response(s) measured by the VNA 224. The processor 226 may also be configured to map the reflected frequency response and/or transmitted frequency response to finger gestures performed by a user wearing the ring.

The electronic circuitry 210 may also include a short-range communication radio generator 230 for generating a transmission signal for the short-range communication antenna 208B. The short-range communication radio generator 230 may be positioned between the processor 226 and the first switch 214. In some embodiments, the electronic circuitry 210 may an NFC charging control element 232 for facilitating wireless charging of a battery using the NFC antenna 208A and/or an NFC payment control element 234 for facilitating a payment transaction using the NFC antenna 208A. The NFC charging control element 232 and the NFC payment control element 234 may be positioned between the processor 226 and the second switch 220.

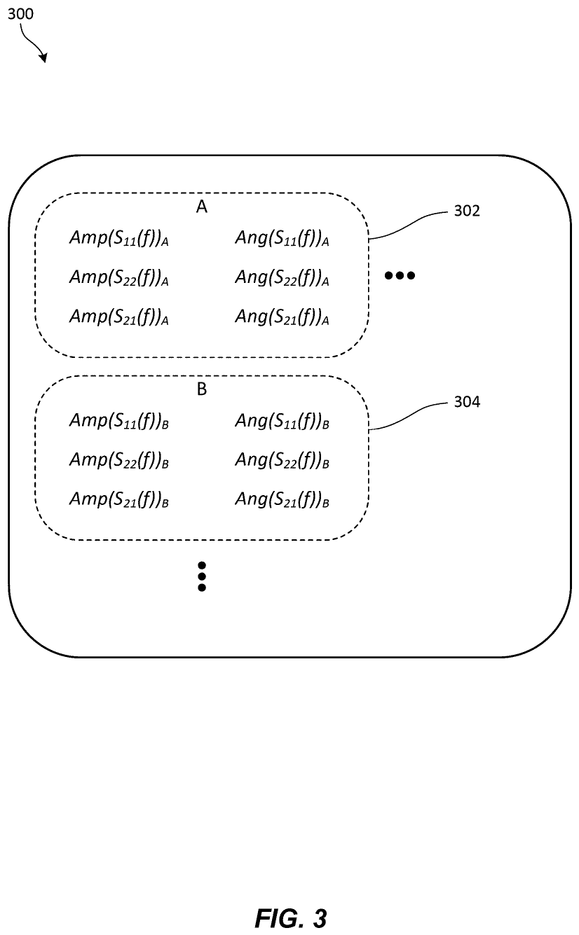

FIG. 3 is an illustration of a frequency response map 300 based on measuring various signal attributes during a finger gesture recognition operation, according to at least one embodiment of the present disclosure.

By way of example, the frequency response map 300 may include entries for a variety of different finger gestures, such as a first entry 302 for the sign language finger gesture associated with the letter “A,” a second entry 304 for the sign language finger gesture associated with the letter “B,” etc. Each of the first entry 302 and the second entry 304 may, in some embodiments, be generated by a VNA (e.g., VNA 124 and/or VNA 224) measuring frequency responses of one or more antennas (e.g., antenna(s) 108, antenna(s) 208) in a ring.

In some embodiments, a user may be instructed to make certain finger gestures while wearing the ring during a learning mode. For example, a connected device (e.g., a mobile device, a personal computer, etc.) may instruct the user to perform a sign language finger gesture for the letter “A.” The VNA of the ring may measure a frequency response during this finger gesture, and the ring (e.g., a processor of the ring, such as processor 126 or processor 226) may record the measurements in the frequency response map 300 in the first entry 302. The connected device may then instruct the user to perform a sign language finger gesture for the letter “B.” The VNA of the ring may measure a frequency response during this finger gesture, and the ring (e.g., a processor of the ring) may record the measurements in the frequency response map 300 in the second entry 304. This process may continue to record frequency responses of additional finger gestures in the frequency response map 300, such as for additional sign language letters, numbers, words, phrases, etc.

The first entry 302 and the second entry 304 may each include one or more frequency response data points. For example, as illustrated in FIG. 3, a frequency response amplitude of a reflected signal at a first port of a VNA may be recorded as Amp(S₁₁(f)), where f refers to the frequency, S refers to a signal measured by the VNA at the frequency f, and Amp refers to the amplitude. A frequency response phase of the reflected signal at the first port of the VNA may be recorded in the frequency response map 300 as Ang(S₁₁(f)), where Ang refers to the phase angle. Similarly, a frequency response amplitude of a reflected signal at a second port of the VNA may be recorded as Amp(S₂₂(f)), and a frequency response phase of the reflected signal at the second port may be recorded as Ang(S₂₂(f)). A frequency response amplitude of a transmitted signal from the first port to the second port of the VNA may be recorded in the frequency response map 300 as Amp(S₂₁(f)), and a frequency response phase of the transmitted signal from the first port to the second port may be recorded as Ang(S₂₁(f)). These parameters are provided by way of example. In additional embodiments, fewer, more, and/or different frequency response measurements may be stored in the frequency response map 300.

During an operational mode, a user may perform a finger gesture. A processor

of the ring may compare a frequency response measured at the VNA during the finger gesture to the frequency response map 300. Thus, the processor may determine which entry of the frequency response map 300 is closest to the measured frequency response to predict which finger gesture is being performed. As noted above, this process can be used for sign language interpretation, for user authentication, or for other purposes. In some embodiments, the frequency response map 300 may be updated with new values, such as in future learning modes, when a new user wears the ring, when the user wears the ring on a different hand and/or finger, based on user feedback, or in other situations.

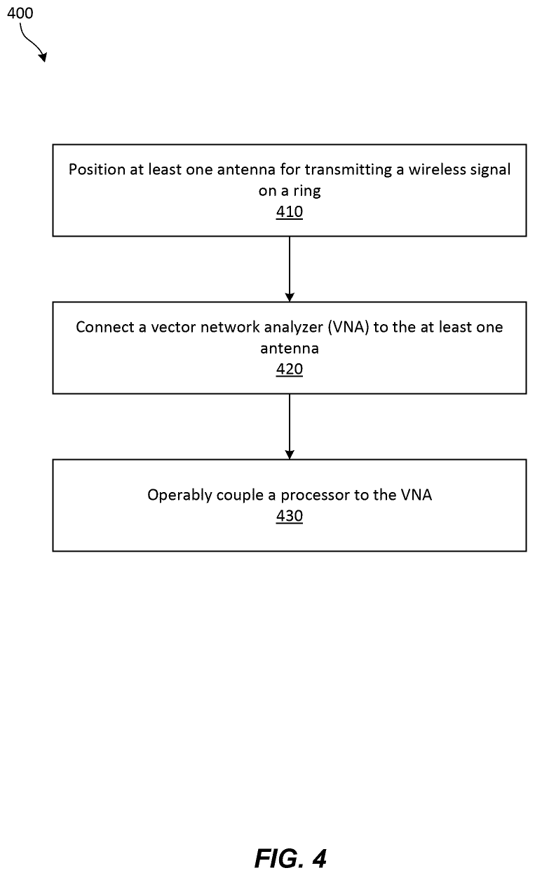

FIG. 4 is a flow diagram illustrating a method 400 of forming a ring with finger gesture recognition capabilities, according to at least one embodiment of the present disclosure. At operation 410, at least one antenna for transmitting a wireless signal may be positioned on a ring shaped and sized for fitting on a finger of a user. For example, one or more antennas may be positioned within a groove formed on an internal surface of the ring. In some embodiments, a short-range communication antenna and/or an NFC antenna may be positioned on the ring.

At operation 420, a vector network analyzer (VNA) may be connected to the antenna(s). The vector network analyzer may be configured to drive a test signal into the antenna(s), and to measure a reflected frequency response of a reflected signal returning to the VNA from the antenna(s). By way of example, the VNA may be positioned on the ring.

At operation 430, a processor may be operably coupled to the VNA. The processor may be configured to map the reflected frequency response to finger gestures to be performed by the user wearing the ring. By way of example, the processor may be positioned on the ring.

In additional examples, the processor may be located remote from the ring, such as in a mobile device, a smartwatch, a personal computer, etc. In such cases, data from the VNA may be transmitted (e.g., wirelessly) to the processor and the processor may be configured to map the reflected frequency response to finger gestures remotely.

In some examples, relational terms, such as “first,” “second,” “inner,” “outer,” etc., may be used for clarity and convenience in understanding the disclosure and accompanying drawings and do not connote or depend on any specific preference, orientation, or order, except where the context clearly indicates otherwise.

Accordingly, the present disclosure includes rings and systems for finger gesture recognition that include at least one antenna, a VNA, and a processor. The VNA may be configured to drive a test signal into the antenna(s) and measure a reflected frequency response. The processor may be configured to map the reflected frequency response to finger gestures performed by a user wearing the ring. Such rings and systems may be capable of recognizing finger gestures, such as for sign language recognition and/or for user authentication.

The following example embodiments are also included in the present disclosure.

Example 1. A ring for finger gesture recognition, the ring including: at least one antenna for transmitting a wireless signal; a vector network analyzer operably coupled to the at least one antenna and configured to: drive a test signal into the at least one antenna; and measure a reflected frequency response of a reflected signal returning to the vector network analyzer from the at least one antenna; and a processor operably coupled to the vector network analyzer and configured to map the reflected frequency response to finger gestures performed by a user wearing the ring.

Example 2. The ring of Example 1, wherein the reflected frequency response includes an amplitude of the reflected frequency response and a phase of the reflected frequency response.

Example 3. The ring of Example 1 or Example 2, wherein the at least one antenna includes: a short-range communication antenna; and a near-field communication (NFC) antenna.

Example 4. The ring of any one of Examples 1 through 3, wherein the vector network analyzer is further configured to measure a transmitted frequency response of the test signal driven by the vector network analyzer into the at least one antenna.

Example 5. The ring of Example 4, wherein the processor is further configured to map the transmitted frequency response to the finger gestures performed by the user wearing the ring.

Example 6. The ring of any one of Examples 1 through 4, further including a microcontroller unit, wherein the processor is a component of the microcontroller unit.

Example 7. The ring of any one of Examples 1 through 6, further including a battery for providing power to the vector network analyzer and the processor.

Example 8. The ring of Example 7, wherein the at least one antenna is positioned along the battery.

Example 9. The ring of any one of Examples 1 through 8, wherein the finger gestures include sign language gestures.

Example 10. The ring of any one of Examples 1 through 9, wherein the processor is further configured to authenticate the user based on the mapped reflected frequency response.

Example 11. The ring of any one of Examples 1 through 10, wherein the test signal driven to the at least one antenna is a continuous test signal over a sampling time period.

Example 12. The ring of any one of Examples 1 through 11, wherein the at least one antenna includes a near-field communication (NFC) antenna configured to at least one of: wirelessly charge the ring; or complete an NFC payment transaction.

Example 13. A system for finger gesture recognition, the system including: a ring shaped and sized for being worn on finger of a user, the ring including: a near-field communication (NFC) antenna; a short-range communication antenna; and a vector network analyzer operably coupled to the NFC antenna and short-range communication antenna and configured to: drive a test signal into the NFC antenna and short-range communication antenna; and measure a reflected frequency response of a reflected signal returning to the vector network analyzer from the NFC antenna and short-range communication antenna; an instructional device in communication with the ring, the instructional device being configured to instruct the user to perform at least one finger gesture; and a processor operably coupled to the vector network analyzer and configured to map the reflected frequency response to the at least one finger gesture performed by the user wearing the ring.

Example 14. The system of Example 13, wherein the processor is positioned in the ring.

Example 15. The system of Example 13 or Example 14, wherein the instructional device includes a display for visually instructing the user to perform the at least one finger gesture.

Example 16. The system of any one of Examples 13 through 15, wherein the instructional device includes an audio speaker for audibly instructing the user to perform the at least one finger gesture.

Example 17. The system of any one of Examples 13 through 16, wherein the instructional device includes at least one of: a mobile device; a mobile phone; a personal computer; a television; a headphone; or a smartwatch.

Example 18. The system of any one of Examples 13 through 17, wherein the vector network analyzer is further configured to measure a transmitted frequency response of a transmitted signal driven by the vector network analyzer into the NFC antenna and short-range communication antenna.

Example 19. A method of forming a ring for finger gesture recognition, the method including: positioning at least one antenna for transmitting a wireless signal on a ring shaped and sized for fitting on a finger of a user; connecting a vector network analyzer to the at least one antenna such that the vector network analyzer can drive a test signal into the at least one antenna and measure a reflected frequency response of a reflected signal returning to the vector network analyzer from the at least one antenna; and operably coupling a processor to the vector network analyzer, the processor being configured to map the reflected frequency response to finger gestures to be performed by the user wearing the ring.

Example 20. The method of Example 19, further including positioning the processor on the ring.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A ring for finger gesture recognition, the ring comprising:
at least one antenna for transmitting a wireless signal;
a vector network analyzer operably coupled to the at least one antenna and configured to:
drive a test signal into the at least one antenna; and
measure a reflected frequency response of a reflected signal returning to the vector network analyzer from the at least one antenna; and
a processor operably coupled to the vector network analyzer and configured to map the reflected frequency response to finger gestures performed by a user wearing the ring.

2. The ring of claim 1, wherein the reflected frequency response comprises an amplitude of the reflected frequency response and a phase of the reflected frequency response.

3. The ring of claim 1, wherein the at least one antenna comprises:
a short-range communication antenna; and
a near-field communication (NFC) antenna.

4. The ring of claim 1, wherein the vector network analyzer is further configured to measure a transmitted frequency response of the test signal driven by the vector network analyzer into the at least one antenna.

5. The ring of claim 4, wherein the processor is further configured to map the transmitted frequency response to the finger gestures performed by the user wearing the ring.

6. The ring of claim 1, further comprising a microcontroller unit, wherein the processor is a component of the microcontroller unit.

7. The ring of claim 1, further comprising a battery for providing power to the vector network analyzer and the processor.

8. The ring of claim 7, wherein the at least one antenna is positioned along the battery.

9. The ring of claim 1, wherein the finger gestures comprise sign language gestures.

10. The ring of claim 1, wherein the processor is further configured to authenticate the user based on the mapped reflected frequency response.

11. The ring of claim 1, wherein the test signal driven to the at least one antenna is a continuous test signal over a sampling time period.

12. The ring of claim 1, wherein the at least one antenna comprises a near-field communication (NFC) antenna configured to at least one of: wirelessly charge the ring; or complete an NFC payment transaction.

13. A system for finger gesture recognition, the system comprising:
a ring shaped and sized for being worn on finger of a user, the ring comprising:
a near-field communication (NFC) antenna;
a short-range communication antenna; and
a vector network analyzer operably coupled to the NFC antenna and short-range communication antenna and configured to:
drive a test signal into the NFC antenna and short-range communication antenna; and
measure a reflected frequency response of a reflected signal returning to the vector network analyzer from the NFC antenna and short-range communication antenna;
an instructional device in communication with the ring, the instructional device being configured to instruct the user to perform at least one finger gesture; and
a processor operably coupled to the vector network analyzer and configured to map the reflected frequency response to the at least one finger gesture performed by the user wearing the ring.

14. The system of claim 13, wherein the processor is positioned in the ring.

15. The system of claim 13, wherein the instructional device comprises a display for visually instructing the user to perform the at least one finger gesture.

16. The system of claim 13, wherein the instructional device comprises an audio speaker for audibly instructing the user to perform the at least one finger gesture.

17. The system of claim 13, wherein the instructional device comprises at least one of:
a mobile device;
a mobile phone;
a personal computer;
a television; a headphone; and
a smartwatch.

18. The system of claim 13, wherein the vector network analyzer is further configured to measure a transmitted frequency response of a transmitted signal driven by the vector network analyzer into the NFC antenna and short-range communication antenna.

19. A method of forming a ring for finger gesture recognition, the method comprising:
positioning at least one antenna for transmitting a wireless signal on a ring shaped and sized for fitting on a finger of a user;
connecting a vector network analyzer to the at least one antenna such that the vector network analyzer can drive a test signal into the at least one antenna and measure a reflected frequency response of a reflected signal returning to the vector network analyzer from the at least one antenna; and
operably coupling a processor to the vector network analyzer, the processor being configured to map the reflected frequency response to finger gestures to be performed by the user wearing the ring.

20. The method of claim 19, further comprising positioning the processor on the ring.
